(19) United States
(12) Patent Application Publication
(10) Pub. No.: US 2026/0024107 A1
(43) Pub. Date: Jan. 22, 2026

(54) NATURAL LANGUAGE USER INTERFACE FOR AN AUTOMATED LOYALTY PROGRAM DESIGNER FRAMEWORK

(71) Applicant: MASTERCARD INTERNATIONAL INCORPORATED, PURCHASE, NY (US)

(72) Inventors: Gerard J. O'Donnell, Wentzville, MO (US); Benjamin Matthew Jack, Tarrytown, NY (US); Georges Neto Makarios, Hollywood, FL (US); Kailey Hensala, O'Fallon, MO (US); Philippe Zay, Miami, FL (US)

(21) Appl. No.: 19/268,960

(22) Filed: Jul. 14, 2025

Related U.S. Application Data
(60) Provisional application No. 63/674,258, filed on Jul. 22, 2024.

(51) Int. Cl. G06Q 30/0226

(52) U.S. Cl. CPC G06Q 30/0226

(57) ABSTRACT

Examples provide a system, method, and computer storage device for automatically designing and presenting loyalty programs in a user interface. Loyalty data is retrieved from a historical transactions database and anonymized by masking and aggregating the data. The anonymized data is encoded into a generative pre-trained transformer and decoded into proposed loyalty programs with a predicted likelihood of consumers to make transactions in that program. The proposed propensity for each proposed loyalty program is compared with a threshold propensity that is a minimum acceptable propensity for consumers to make transactions in any loyalty program. Based on the comparison, a relative effectiveness of each proposed loyalty program is determined. Each proposed loyalty program is presented as a natural language icon in a graphical user interface (GUI) and the natural language icons are automatically moved to a list in the GUI in descending order of relative effectiveness.

### BACKGROUND

Efficiently presenting information in user interfaces in a manner that is easily understandable and actionable by users is a significant challenge in the field of user interface design. Many modern devices, particularly smartphones, computers, and other electronic interfaces, provide access to a wide variety of complex technical functions and data. However, inefficiencies in user interface design can lead to user frustration, errors, and a lack of engagement with the full functionality of the device.

Existing solutions frequently fail to strike a balance between providing sufficient detail to inform decision-making and simplifying the presentation of information to maintain usability. Users are often required to navigate through multiple layers of menus, decipher obscure terminology, or interpret raw technical data when presented with information that is used to make decisions. These issues are encountered by users with existing user interfaces.

### SUMMARY

Some examples provide a system for automatically designing loyalty programs. The system retrieves loyalty data from a database of historical transactions. The loyalty data has loyalty program activity data that describes attributes of loyalty programs and loyalty consumer activity data that describes consumer transactions associated with a loyalty program. The loyalty data is anonymized such that any individual identifying information is masked and loyalty consumer activity data is aggregated. The system encodes the anonymized loyalty data into representations for transformation by a generative pre-trained transformer (GPT). The GPT decodes the representations into a plurality of proposed loyalty programs and a proposed propensity for each proposed loyalty program. The proposed propensity is a likelihood for consumers to make transactions for a given loyalty program. The system compares the proposed propensity for each proposed loyalty program with a threshold propensity that is a minimum acceptable propensity for consumers to make transactions in a loyalty program. Based on comparing the proposed propensity for each proposed loyalty program with the threshold propensity, the system determines a relative effectiveness of each proposed loyalty program, presents each proposed loyalty program as a natural language icon in a graphical user interface (GUI), and automatically moves the natural language icons to a list in the GUI in descending order of relative effectiveness.

Other examples provide a method for automatically designing loyalty programs. Loyalty data that has loyalty program activity data that describes attributes of loyalty programs and loyalty consumer activity data that describes consumer transactions associated with a loyalty program is retrieved from a database of historical transactions. The loyalty data is anonymized by masking any individual identifying information is masked and aggregating the loyalty consumer activity data. The anonymized loyalty data is encoded into representations for transformation by a generative pre-trained transformer (GPT). The GPT decodes the representations into a plurality of proposed loyalty programs and a proposed propensity for each proposed loyalty program. The proposed propensity is a likelihood for consumers to make transactions for a given loyalty program. The proposed propensity for each proposed loyalty program is compared with a threshold propensity-a minimum acceptable propensity for consumers to make transactions in any loyalty program. Based on comparing the proposed propensity for each proposed loyalty program with the threshold propensity, a relative effectiveness of each proposed loyalty program is determined. Each proposed loyalty program is presented as a natural language icon in a graphical user interface (GUI) and the natural language icons are automatically moved to a list in the GUI in descending order of relative effectiveness.

Still other examples provide a computer storage device having computer-executable instructions stored thereon, which, upon execution by a computer, cause the computer to retrieve loyalty data from a database of historical transactions. The loyalty data has loyalty program activity data that describes attributes of loyalty programs and loyalty consumer activity data that describes consumer transactions associated with a loyalty program. The loyalty data is anonymized such that any individual identifying information is masked and loyalty consumer activity data is aggregated. The computer encodes the anonymized loyalty data into representations for transformation by a generative pre-trained transformer (GPT). The computer decodes the representations into a plurality of proposed loyalty programs and a proposed propensity for each proposed loyalty program. The proposed propensity is a likelihood for consumers to make transactions for a given loyalty program. The computer compares the proposed propensity for each proposed loyalty program with a threshold propensity that is a minimum acceptable propensity for consumers to make transactions in a loyalty program. Based on comparing the proposed propensity for each proposed loyalty program with the threshold propensity, the computer determines a relative effectiveness of each proposed loyalty program, presents each proposed loyalty program as a natural language icon in a graphical user interface (GUI), and automatically moves the natural language icons to a list in the GUI in descending order of relative effectiveness.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present description will be better understood from the following detailed description read considering the accompanying drawings, wherein:

FIG. 1 is an exemplary block diagram illustrating a system for automatically generating and presenting loyalty programs on a user interface.

FIG. 2 is an exemplary block diagram illustrating a system including propensity segment exemplars for determining a consumer propensity for automatically generating and presenting loyalty programs on a user interface.

FIG. 3 is an exemplary flow chart illustrating operation of the computing device to generate and present loyalty programs on a user interface.

FIG. 4 is an exemplary flow chart illustrating operation of the computing device to perform natural language processing to generate and present loyalty programs on a user interface.

FIG. 5A is an exemplary user interface displaying a text-based conversation of a user with the automated loyalty program designer user interface.

FIG. 5B is an exemplary user interface displaying a continued text-based conversation of a user with the automated loyalty program designer user interface.

FIG. 6 illustrates a computing apparatus according to an embodiment as a functional block diagram.

Corresponding reference characters indicate corresponding parts throughout the drawings. Any of the figures may be combined into a single example or embodiment.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Existing user interfaces provide a barrier to entry for many non-technical users. Traditional graphical user interfaces (GUIs) of programs depend on a user's knowledge and experience to understand the purpose of elements presented on a display. This issue is compounded when a program requires subject-matter expertise to use the program. Icons or elements might be labelled with subject-matter specific terminology that are not readily understood by non-technical users. The presentation of information not known to non-technical users in a GUI often requires the user to spend additional time researching the meaning of unknown terms or otherwise attempt to proceed through the program through trial and error. The additional mental resources and research needed to use the program causes additional friction and time spent using the program.

Furthermore, information may be presented in an unintuitive way to non-technical users—requiring the users to search for the information that they are looking for. For example, a user reading through a list of options that are not arranged in a manner ranked by a metric that is relevant to the user requires the user to parse through each option to determine that ranking themselves. Additional mental load is placed on the user to understand the sought metric, especially if the user lacks subject-matter knowledge or expertise, thereby causing additional friction and time spent using the program. These user-interface issues are at least found when non-technical users attempt to create loyalty programs. Repeated interactions of the users with the computing device, e.g., in search of relevant options, render additional processing load on the computing device.

Many organizations recognize the value of loyalty programs. However, a user tasked with coming up with and implementing loyalty programs may not have the expertise and knowledge to optimize their program for success. A user might know what they want would still likely not have the technical or subject matter expertise to set up and implement a loyalty program. Current approaches for designing loyalty programs require an individual to communicate their needs to an external party as a first step that feeds into a time-consuming onboarding process. Coordinating this effort between subject matter experts and the user is cumbersome and inherently risky. Miscommunication and misunderstanding can require rework or additional expense.

In contrast, aspects of the disclosure provide a user interface system for automatically designing loyalty programs using natural language. A system for automatically designing loyalty programs can comprise a processor and a computer storage medium retrieving loyalty data describing attributes of loyalty programs and data describing consumer transactions associated with a corresponding loyalty program. The system anonymizes the loyalty data and determines a proposed propensity that is a likelihood for consumers to make transactions for one or more given loyalty program and reward criteria within each program. The system encodes the anonymized loyalty data and determined propensity into representations for transformation by a generative pre-trained transformer (GPT) and decodes the representations from the GPT into proposed loyalty programs. The system compares the proposed propensity for each program against a threshold propensity that is a minimum acceptable propensity for consumers to make transactions in any loyalty program to determine a relative effectiveness for each program. The system stores and presents each loyalty program as an icon in a GUI and automatically moves the loyalty program icons in a descending list based on the program's determined relative effectiveness.

A technical solution to the technical problems of traditional loyalty-program onboarding is a generative artificial intelligence (AI) interface that proposes loyalty programs that are customized to a user's dataset. The generative AI provides proposed loyalty programs that are listed on a user interface (UI) in order from most effective to least effective. This enables a user to receive proposed loyalty programs that are customized for that particular user.

The computing device operates in an unconventional manner at least by recurrently weighting proposed loyalty program outputs from the generative AI by the consumer propensity analysis module. In this manner, the computing device is used in an unconventional way, and allows a user to receive only the proposed loyalty programs that pass/survive the consumer propensity analysis, thereby improving the functioning of the underlying computing device while reducing system resource usage.

Further, aspects of the disclosure improve the usability of the underlying device at least by automatically moving an icon representing the most effective proposed loyalty programs to the top of a descending list on a UI. User interaction performance is also improved via the natural language query UI as described herein. This improves the human-machine interaction.

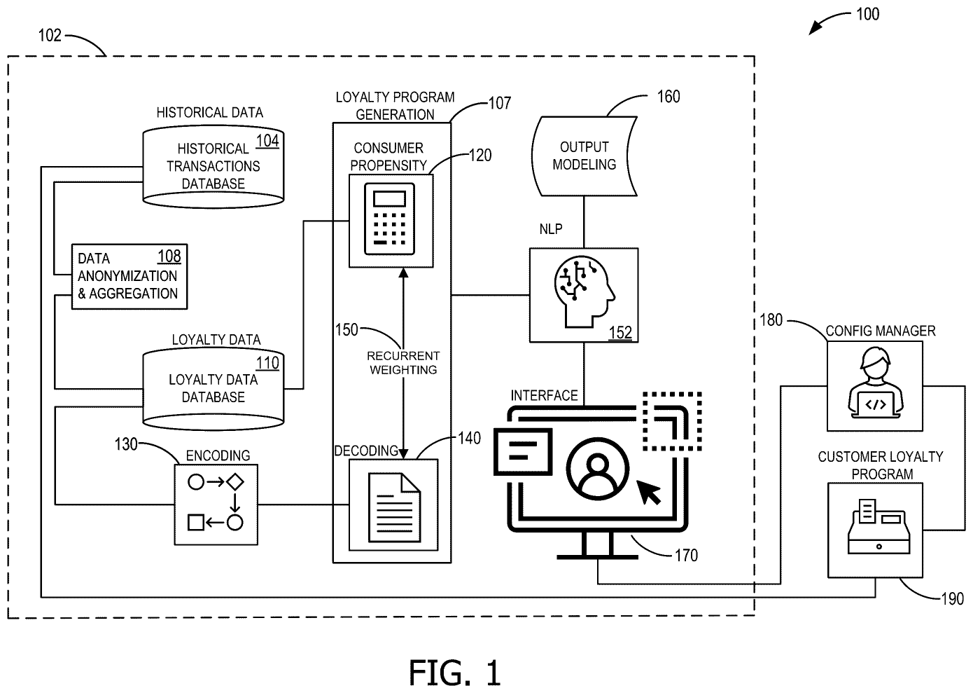

Referring to FIG. 1, an exemplary block diagram illustrates a system 100 of an automated loyalty designer (ALD) framework 102 on a computer storage medium, The computer storage medium stores instructions for automatically designing and presenting loyalty programs. A loyalty program can involve the making available of one or more rewards for fulfilling one or more terms and/or conditions over a specified frequency or duration to specific consumers. A loyalty program can be designed to incentivize particular consumer behaviors-either singularly or collectively. The ALD framework 102 can at least comprise virtual modules, data stores, processor instructions, program processes, GPTs, user interfaces, and data structures. The computer storage medium storing instructions can represent any type of computing device/computer storage device executing instructions, such as application programs, operating system functionality, or both. The computing device, in some examples includes a mobile computing device or any other portable device. A mobile computing device includes, for example but without limitation, a mobile telephone, laptop, tablet, computing pad, netbook, gaming device, and/or portable media player. The computing device can also include less-portable devices such as servers, desktop personal computers, kiosks, or tabletop devices. Additionally, the computing device can represent a group of processing units or other computing devices.

In some examples, the application programs include a historical transactions database 104. The historical transactions database 104 can be a database management system that can comprise datastores and interfacing software. The historical transactions database 104 stores loyalty data on a data store, such as a database. The loyalty data is data describing loyalty program activity, such as loyalty program attributes, rewards, reward criteria, and consumer activity related to loyalty programs, such as consumer transaction data while enrolled in a loyalty program. The loyalty consumer activity data can include transaction data related to a consumer's decision to accept or reject an offered loyalty program. The loyalty data contains inherent identifying information about the consumer and merchants. To protect consumer and merchant privacy and anonymity, the loyalty data is anonymized and aggregated 108 to remove identifying information. Anonymization can include the removal of personally identifiable information, such as a consumer's name, age, address, and social security number. Alternatively, anonymization can include the masking of personally identifiable information to preserve realistic data entries for the consumer propensity analysis. Aggregation of data further protects privacy by preventing each data source from being used in isolation.

After identifying information is removed from the historical transactions data and aggregated, the anonymized loyalty data is stored in a loyalty data datastore 110 as loyalty data. The loyalty data database 110 can be a database management system that can comprise datastores and interfacing software. In some examples, the historical transactions database 104 can be operated on a physically separate computing device from the loyalty data database 110. As shown in FIG. 1, in other examples, the databases can be separate datastores on the same computing device. In yet other examples, the loyalty data database 110 can occupy the same datastore that the historical transactions database 104 occupied, but with the loyalty data transformed to remove identifying information.

After the loyalty data is anonymized, the system can use the data to determine a proposed propensity for consumers to make transactions. The proposed propensity can include a likelihood that a consumer will make transactions for a given loyalty program. The proposed propensity can also include a proposed number of transactions a consumer will make under a given loyalty program, a proposed likelihood that a consumer will enroll in a given loyalty program, a proposed spend volume under the given loyalty program, a proposed loyalty impact of the loyalty program, and a proposed profitability for a user implementing the given loyalty program. For the purposes of this disclosure, a given loyalty program is any single loyalty program and can include proposed loyalty programs. Also, for the purposes of this disclosure, an example user is an individual that can interact with the ALD framework 102 via a graphical user interface (GUI) 170. The proposed loyalty impact can be a measure of the difference a given loyalty program makes on a consumer's normal spending habits. Determining a proposed loyalty impact may require additional transaction data beyond consumer transaction data related to loyalty programs. The additional transaction data provides context for a consumer's loyalty activity data and allows the system to measure the relative impact of a given loyalty program for that consumer.

The system can also include a threshold propensity that is a minimum acceptable propensity for consumers to make transactions in any loyalty program. The threshold propensity can include any of the elements of the proposed propensity. The threshold propensity can be manually set by a user or can be determined by the system by analyzing multiple proposed propensities, or both.

The system can determine the threshold propensity with a consumer propensity analysis module 120. The consumer propensity analysis module 120 analyzes the anonymized loyalty data to identify trends in and generate analytics of the loyalty data. The consumer propensity analysis module 120 includes weights for different loyalty program attributes. A weight of the propensity determination can influence the impact of that loyalty program's attribute on the program's relative effectiveness.

The consumer propensity analysis module 120 can perform statistical modelling, such as a regression analysis, to isolate the impact of specific loyalty program attributes on consumer transaction behavior. For example, loyalty programs that offer frequent rewards might positively correlate with increased consumer spending behavior. The consumer propensity analysis module 120 can also model multiple loyalty programs in the aggregate, their historical performance, the consumer segmentation of users that enroll in a given loyalty program, the spending impact on consumer behavior, and the profitability for users implementing the loyalty programs.

System 100 can encode the anonymized loyalty data into representations usable by a generative pre-trained transformer (GPT). The system 100 can encode the anonymized loyalty data through an encoding module 130. The GPT can include multiple modules or computing devices within the system 100. Encoding the loyalty data into representations that the GPT can use enables the GPT to perform repeated transformations on the representations. The repeated transformations can extract linguistic information from the data to generate proposed loyalty programs. In some examples, the GPT is an existing large-language model that accepts loyalty data as one of a plurality of data sources encoded into the GPT.

After the loyalty data is encoded, the GPT can decode the representations into proposed loyalty programs. In some embodiments, the proposed loyalty programs can include one or more offers to customers. The one or more offers can include a reward for the customer executing a specific behavior in a specified time. The system 100 can decode the representations through a decoding module 140. The proposed loyalty programs can include program attributes as well as a proposed consumer propensity and a proposed profitability for implementing the loyalty program. The proposed consumer propensity can include any of the attributes of the threshold propensity, and in some cases includes all attributes found in the threshold propensity. In some examples, the loyalty programs initially proposed by the GPT may not be effective because they are purely the result of the GPT and the input anonymized loyalty data. The GPT does not understand, by itself, what makes a proposed loyalty program effective or not.

In some embodiments, the encoding module 130 of the GPT, the decoding module 140 of the GPT, or both can be external to the ALD framework 102. In these embodiments, the modules are external to the GPT itself and can be a single element, but provide the same inputs and outputs to the connected elements in this disclosure. Further, in other embodiments, the consumer propensity analysis module 120 is built into the decoding module 140 itself. The recurrent weighting 150, described below, occurs by repeatedly decoding the representations through the decoding module 140.

The proposed loyalty programs decoded from the GPT can be recurrently weighted 150 from the consumer propensity analysis. The recurrent weighting 150 can include the consumer propensity analysis determining the effectiveness of the GPT's proposed loyalty programs. The proposed loyalty programs can be compared against historical transactions to determine whether a proposed loyalty program is both effective and realistic to implement. The consumer propensity analysis can also analyze a consumer's response to offered loyalty programs and model consumer responses based on attributes of previously offered loyalty programs. Modeling consumer responses can include statistical regressive modeling to isolate the relative impact of a program attribute on whether a consumer enrolls, not enrolls, or remains inactive in a loyalty program. Additionally, the attributes of a proposed loyalty program can be assessed in the consumer propensity analysis to determine a proposed consumer propensity for the program. The proposed consumer propensity can be compared to the threshold consumer propensity to determine a relative effectiveness for each program.

The recurrent weighting 150 can include reinforced learning from human feedback (RLHF). Operators of the system 100 can review the proposed loyalty programs weighted from the consumer propensity analysis and can change aspects of the weighting metrics. For the purpose of this disclosure, an example operator is a human operator of the ALD framework 102 that has authority to perform RLHF and modify the framework. Repeated changes to the weighting metrics from human operators improve the effectiveness of the GPT's proposed loyalty programs. Without RLHF, the recurrent weighting 150 between the GPT and the consumer propensity analysis might produce proposed loyalty programs that are optimized for consumer engagement or transaction volume, but that would be unprofitable or unrealistic for a user to actually implement. For example, a proposed loyalty program that provides a large financial incentive to consumers might lead to high engagement but would cause lowered profitability for the user as a result. In another example, a proposed loyalty program that fails to give certain financial incentives promised might raise the user's profitability but would be illegal if implemented.

The recurrent weighting 150 can also include RLHF to determine how a proposed consumer propensity of a loyalty program is compared to the threshold consumer propensity. Because loyalty programs are likely to have different combinations of loyalty program attributes, RLHF enables operators of the system 100 to set a relative weighting for each attribute individually or implement formulas to determine the relative weighting for each attribute. By setting a relative weighting for each attribute, system 100 operators essentially train the system 100 to produce loyalty programs that reflect the operator's desired traits for the loyalty program. RLHF thus prevents undesired loyalty programs from being presented to the user.

In some embodiments, RLHF can also add data to encoding module 130 or can modify the representations at the encoding module 130. Further, in some embodiments, a determined relative effectiveness for each program, or other program attributes, such as a proposed profitability, can be sent to be encoded at encoding module 130 for transformation by the GPT to further train the GPT. The disclosure recognizes that the recurrent weighting 150 and the RLHF can modify the proposed loyalty programs either through entering additional data to the GPT at the encoding module 130, by filtering the proposed loyalty programs output through the decoding module 140, or both in various embodiments.

The consumer propensity module 120, the decoding module 140 of the GPT, and the recurrent weighting 150 can collectively comprise a section of the system 100 configured for loyalty program generation 107. After a specified number of recurrent weightings 150, in response to a query from a user, or some other condition, the loyalty program generation section 107 sends the proposed loyalty programs to a natural language processing (NLP) module 152.

The NLP module 152 transforms the proposed loyalty program into natural language to be presented to a user on a UI. The NLP module 152 can be part of the GPT that generates the proposed loyalty programs, it can be a standalone GPT, or can be a separate computing module. The NLP module 152 can generate a natural language description of the proposed loyalty program in response to a user query on the GUI 170.

In some examples, an output modeling module 160 using the user's own data can act as a filter for proposed loyalty programs. The output modeling module 160 can perform regressive modeling to ensure that a proposed loyalty program is not a moonshot or otherwise impractical to implement for the user. The output modeling module 160 can send the regressive modeling results to be presented to the user via the NLP module 152. The NLP module 152 prioritizes the output modeling results over the proposed loyalty programs when generating natural language description of the proposed loyalty programs. Further, in some embodiments, the user's own data can be encoded into the encoding module 130 to further train the GPT on the user's data. In yet further embodiments, the GPT only decodes proposed loyalty programs that are compatible with the user's consumer data. The user's consumer data can include loyalty data of the user's consumers, such as loyalty data from cardholders enrolled in a card issuer's loyalty program.

The GUI 170 allows a user to query the system 100 for proposed loyalty programs. The GUI 170 can be a natural-language based GUI that enables users to ask the system 100 to come up with proposed loyalty programs. In response to a query, the system 100 generates a visual icon representing a proposed loyalty program that is presented on the GUI 170. The icon can be an image, a text description, some combination of both, or some other visual representation. The visual icon can also include a natural language description of the proposed loyalty program-a natural language icon. Multiple loyalty programs can be presented on the GUI 170 to the user as options for the user to choose to implement. The system 100 can automatically move the loyalty program icons to a position on the GUI in a descending list based on the determined relative effectiveness. By automatically moving the icons in a descending list, the system 100 improves the human-computer interaction users experience with the GUI 170.

In some examples, the system 100 includes a configuration manager tool 180 that enables operators to modify the system 100 as implemented on the computing device. The configuration manager tool 180 includes a UI for an operator to configure or setup the system 100. In some examples, operators use the configuration manager tool 180 to perform RLHF for the recurrent weighting 150. Operators can also use the configuration manager tool 180 to set guardrails and boundaries for the types of proposed loyalty programs generated by the GPT as well as the natural language generated by the NLP module 152. The configuration manager tool 180 can also enable operators to limit a user's access to the system 100 from certain sections of data, modules, or functions.

After a user selects a proposed loyalty program from the GUI 170 to implement, the system 100 can assist the user in implementing the selected loyalty program with the customer loyalty program module 190. In some examples, the system 100 implements the selected loyalty program, or causes or instructs the selected loyalty program to be implemented. The customer loyalty program module 190 can record and store loyalty data of consumers making transactions as part of the chosen loyalty program. This loyalty data can be sent to the historical transactions database 104 to further improve the ALD framework 102, and thus improve the quality and effectiveness of the proposed loyalty programs.

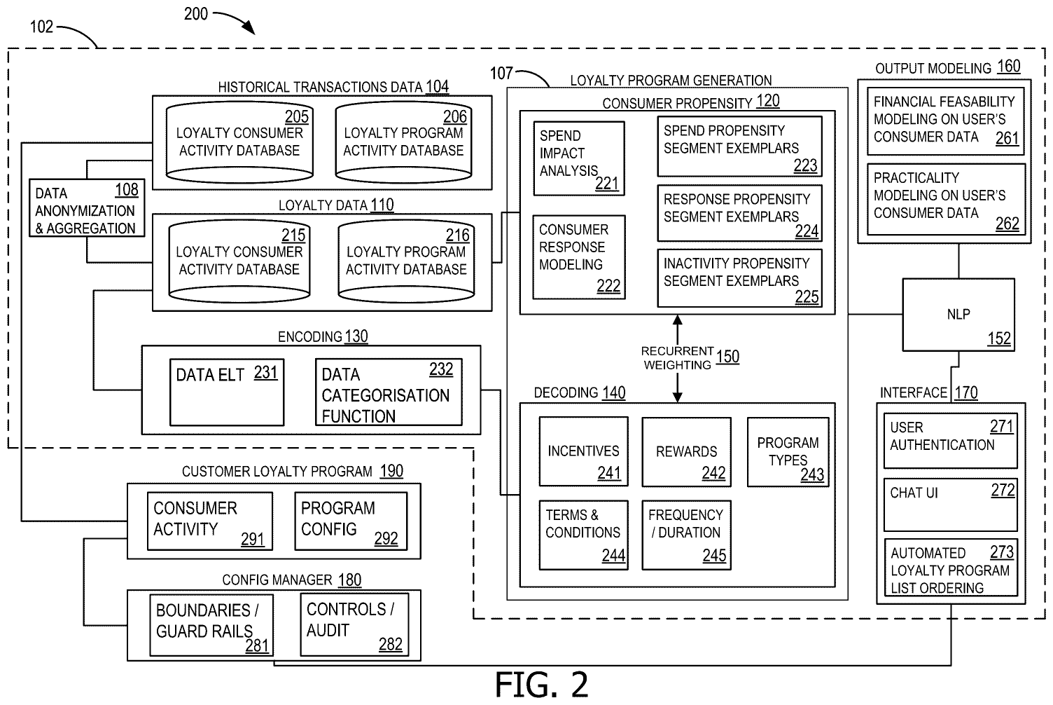

FIG. 2 is an exemplary block diagram illustrating a system 200 using an ALD framework 102 for automatically designing and presenting loyalty programs on a computing device. In the example of FIG. 2, the computing device represents any device executing computer-executable instructions (e.g., as application programs, operating system functionality, or both) to implement the operations and functionality associated with the computing device. Some aspects of the system 200 can be implemented as described above in FIG. 1.

The historical transactions database 104 stores loyalty data on a data store, such as a database. Loyalty data comprises data related to loyalty program consumer activity and loyalty program activity. Loyalty program consumer activity data can be stored in a loyalty consumer activity database 205. Similarly, loyalty program activity data can be stored in a loyalty program activity database 206. In some implementations, separating the data groups into distinct datastores can improve the computational efficiency of the consumer propensity analysis, thereby reducing the computational resources used to implement the disclosure. To protect consumer and merchant privacy and anonymity, the loyalty data is anonymized and aggregated by data anonymization and aggregation module 108 to remove identifying information.

After identifying information is removed from the historical transactions data and aggregated, the anonymized loyalty data is stored in a loyalty data datastore 110, such as a database, as loyalty data. Anonymized loyalty program consumer activity data can be stored in a loyalty consumer activity database 215. Similarly, anonymized loyalty program activity data can be stored in a loyalty program activity database 216.

After the loyalty data is anonymized, the system 200 can use the data to determine a propensity threshold for consumers to make transactions using a consumer propensity analysis module 120. The consumer propensity analysis module 120 can perform a spend impact analysis 221 to determine the impact a loyalty program had on a consumer's spending behavior. The consumer propensity analysis module 120 can also perform consumer response modeling 222 to determine how a consumer would likely respond to an offered loyalty program.

The consumer propensity analysis module 120 can consider spend propensity segment exemplars 223, response propensity segment exemplars 224, and inactivity propensity segment exemplars 225 for the consumer propensity analysis. Spend propensity segment exemplars 223 can be loyalty data sources that show a high propensity for consumers to make high payment volumes while enrolled in the loyalty program. Response propensity segment exemplars 224 can be loyalty data sources that show a high propensity for consumers to make numerous transactions while enrolled in the loyalty program or who choose to interact with the loyalty program in some way or can include negative exemplars of consumers who reject enrolling in an offered loyalty program. The inactivity propensity segment exemplars 225 can be loyalty data sources that show a high propensity for consumers to avoid making transactions while enrolled in a loyalty program. The consumer propensity analysis module 120 can use spend propensity segment exemplars 223, response propensity segment exemplars 224, and inactivity propensity segment exemplars 225 to assist in determining the effectiveness of loyalty programs.

The system 200 can encode the anonymized loyalty data through an encoding module 130 of a GPT. The encoding module can perform an extract, load, and transform (ELT) function 231 to encode the loyalty data into representations usable by the GPT. The encoding module 130 can also perform a data categorization function 232 to categorize the loyalty data representations into data structures usable by the GPT.

The system 200 can decode the loyalty data representations into proposed loyalty programs through a decoding module 140 of the GPT. The proposed loyalty programs can include loyalty program attributes such as incentives to enroll in the loyalty program 241, loyalty program rewards 242, the type of loyalty program 243, the terms and conditions for the loyalty program 244, and the frequency/duration of the loyalty program 245.

The proposed loyalty programs decoded from the GPT can be recurrently weighted 150 from the consumer propensity analysis. The proposed consumer propensity of the loyalty program can be compared to the threshold consumer propensity to determine a relative effectiveness for each program. The system 200 can use the determined relative effectiveness to train the GPT to propose more-effective loyalty programs. The recurrent weighting 150 can include reinforced learning from human feedback (RLHF). Operators of the system 100 can review the proposed loyalty programs weighted from the consumer propensity analysis and can change aspects of the weighting metrics.

The consumer propensity module 120, the decoding module 140 of the GPT, and the recurrent weighting 150 can collectively comprise a section of the system 100 configured for loyalty program generation 107. After a specified number of recurrent weightings 150, in response to a query from a user, or some other condition, the loyalty program generation section 107 sends the proposed loyalty programs to a natural language processing (NLP) module 152.

The NLP module 152 transforms the proposed loyalty program into natural language to be presented to a user on a UI. The NLP module 152 can generate a natural language description of the proposed loyalty program in response to a user query on the GUI 170.

In some examples, an output modeling module 160 using the user's own data can act as a filter for proposed loyalty programs. The output modeling module 160 can perform regressive modeling on the user's consumer data. The module 160 can perform financial feasibility modeling on the user's consumer data 261 to ensure that a proposed loyalty program is financially feasible for the user to implement. The module 160 can also perform practicality modeling on the user's consumer data 262 to determine if the proposed loyalty programs are practical for the user to implement for their organization. The output modeling module 160 can send the regressive modeling results to be presented to the user via the NLP module 152. In some embodiments, the financial feasibility modeling on user's consumer data 261 and practicality modeling on user's consumer data 262 can act as a filter to prevent the natural language processing module 152 from including a proposed loyalty program that is incompatible with the financial feasibility modeling on user's consumer data 261 and practicality modeling on user's consumer data 262.

A graphical user interface GUI 170 allows a user to query the system 200 for proposed loyalty programs. The GUI 170 first performs a user authentication function 271 to authenticate the user's credentials. The GUI 170 can include a text-based natural-language UI 272 that enables users to query the system 200 to come up with proposed loyalty programs. A user can enter a text-based query in natural language, such as plain English, to request proposed loyalty programs. The text-based natural language UI 272 allows a non-technical user to use natural language to interface with the ALD framework 102, thereby improving the human-machine interaction for users.

In response to a query, the system 200 generates a visual icon representing a proposed loyalty program that is presented on the GUI 170. The visual icon can include a natural language description of the proposed loyalty program. An automated loyalty program list ordering module 273 can automatically move the loyalty program icons to a position on the GUI 170 in a descending list based on the determined relative effectiveness.

In some examples, the system 200 can include a configuration manager tool 180 that enables operators to modify the system 200 as implemented on the computing device via a UI. Operators can also use the configuration manager tool 180 to set guardrails and boundaries 281 for the types of proposed loyalty programs generated by the GPT as well as the natural language generated by the NLP module 152. Operators can also use the configuration manager tool 180 to control or audit 282 the loyalty program generation modules 107.

After a user selects a proposed loyalty program from the GUI 170 to implement, the system 200 can assist the user in implementing the selected loyalty program with the customer loyalty program module 190. The customer loyalty program module 190 can record and store consumer activity data 291 for consumers participating in the loyalty program. The customer loyalty program module 190 can also record and store loyalty program activity data 292 of the loyalty program. This loyalty data can be sent to the historical transactions database 104 to further improve the ALD framework 102.

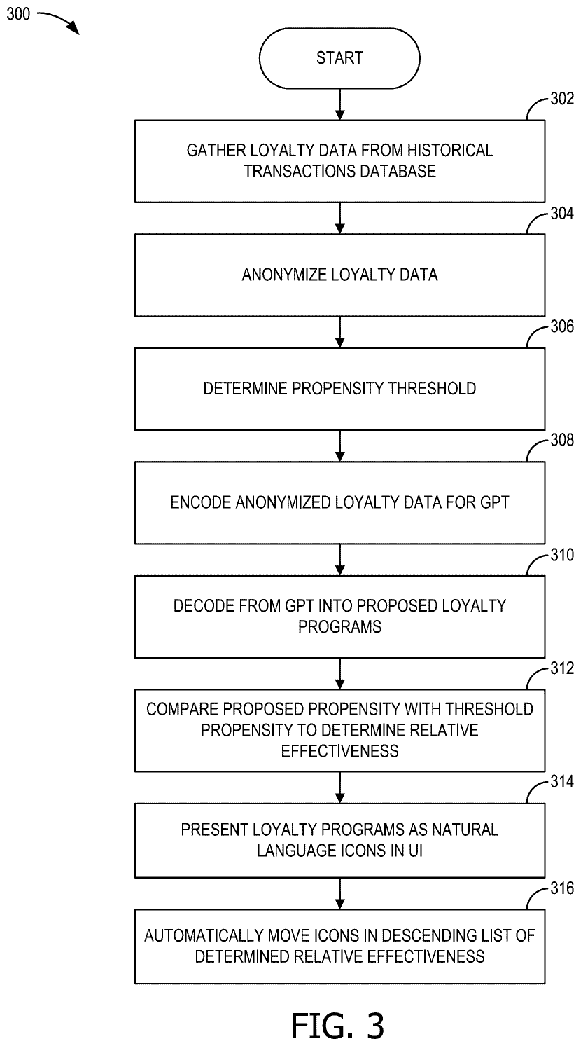

FIG. 3 is an exemplary flow chart 300 illustrating operation of the computing device for automatically designing and presenting loyalty programs. The process shown in FIG. 3 is implemented by the ALD framework executing on a computing device, such as, but not limited to, the computing device of FIG. 1 and FIG. 2.

The process begins with gathering loyalty data from a historical transactions database at 302. The loyalty data can comprise loyalty program activity data and loyalty consumer activity data. The loyalty program activity data can describe attributes of loyalty programs. The loyalty consumer activity data can describe consumer transaction behavior to offered loyalty programs and can further include transaction data following a consumer decision to accept or reject the offered loyalty program including the result of the decision itself.

The process continues with anonymizing the loyalty data at 304. Any individual identifying information of the loyalty data can be masked, thereby protecting consumer privacy. Additionally, the loyalty consumer activity data of the loyalty data can be aggregated, thereby preventing any loyalty consumer's data source from being isolated.

Next, the process determines a threshold propensity for users to make transactions based on a loyalty program at 306. The determination can be based on a loyalty program with specified attributes and a proposed profitability. The threshold propensity is a minimum acceptable propensity for consumers to make transactions in any loyalty program. In some embodiments, the threshold propensity is manually set by a user. The process then encodes the anonymized loyalty data into representations for transformation by a GPT at 308. The process decodes the representations from the GPT into proposed loyalty programs at 310. The decoded representations from the GPT can also include a proposed propensity for consumers to make transactions based on each proposed loyalty program.

Then, the process compares the proposed propensity of the proposed loyalty program with the threshold propensity to determine a relative effectiveness for each proposed loyalty program at 312. The relative effectiveness for each program can be sent to be encoded for representation for transformation by the GPT to further train the GPT. Additionally, an operator can modify a weight used to determine the threshold propensity to reduce aberrative proposed loyalty programs, such as proposed programs that greatly exceed the user's promotion budget, or those that are impractical for the user to implement. In other embodiments, an operator can perform any other form of RLHF to train the GPT.

Next, the process presents loyalty programs as icons in a UI at 314. The UI can be a GUI. The icons can be images, text descriptions, some combination of both, or some other visual representations. Finally, the process automatically moves the loyalty program icons in a descending list based on determined relative effectiveness at 316. If the UI is a GUI, then the process can automatically move the icons to a position on the GUI in a descending list.

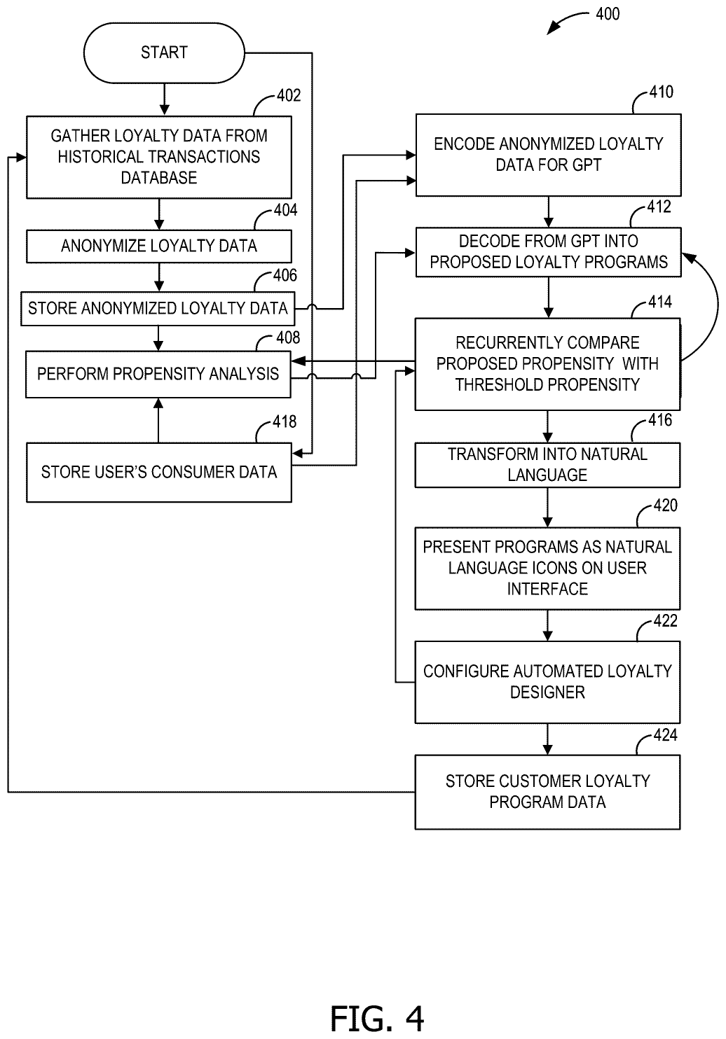

FIG. 4 is an exemplary flow chart 400 illustrating operation of an ALD framework for automatically designing and presenting loyalty programs. The process shown in FIG. 4 is implemented by an ALD framework executing on a computing device, such as, but not limited to, the ALD framework executing on a computing device as shown in FIG. 1 and FIG. 2.

The process begins with gathering loyalty data from a historical transactions database at 402 and storing the user's consumer data at 418. The loyalty data can comprise loyalty program activity data and loyalty consumer activity data. The loyalty program activity data can describe attributes of loyalty programs. Storing the user's consumer data can involve storing a user's loyalty data specific to the user's consumers and loyalty programs.

The process continues with anonymizing the loyalty data at 404 before storing the anonymized loyalty data in a datastore at 406. Next, the process performs a propensity analysis for users to make transactions based on a loyalty program at 408. The propensity analysis can determine a threshold propensity for consumers to make transactions. The determination can be based on a loyalty program with specified attributes and a proposed profitability. The stored user's consumer data at 418 can be incorporated into the propensity analysis such that the propensity analysis at 408 only determines a propensity of loyalty programs compatible with the user's consumer data.

The process then encodes the anonymized loyalty data from the datastore into representations for transformation by a GPT at 410. Additionally, the process can also encode the stored user's consumer data at 418 into representations for transformation by the GPT at 410. After the data is encoded, the process decodes the representations from the GPT into proposed loyalty programs at 412. The decoded representations from the GPT can also include a proposed propensity for consumers to make transactions based on each proposed loyalty program. The determined threshold propensity or other program attributes from the propensity analysis at 408 can be input into the GPT at 412.

Then, the process recurrently compares the proposed loyalty program propensity with the threshold propensity at 414. The recurrent comparison determines a relative effectiveness for each proposed loyalty program. The recurrent comparison can involve sending a proposed loyalty program to the propensity analysis at 408. Additionally, the recurrent comparison can change the configuration of the GPT decoding the representations at step 412. The comparison can use RLHF to train the GPT by enabling an operator to configure the propensity analysis and to modify the weights given to certain loyalty program attributes.

Next, the process transforms the proposed loyalty programs into natural language at 416. At step 418, if a user has provided its consumer data to the ALD framework, then the loyalty programs are modeled on the user's consumer data. The user's consumer data can influence the propensity analysis to better align the proposed loyalty programs with the user's existing programs. In at least one example, the propensity analysis only determines a propensity of loyalty programs compatible with the user's consumer data. In some embodiments, the user's consumer data can act as a filter to prevent the natural language modeling from including a proposed loyalty program that is incompatible with the user's consumer data.

The process then presents loyalty programs as icons in a UI at 420. The UI can be a GUI. The icons can be images, text descriptions, some combination of both, or some other visual representations. The process can also present graphical representations of loyalty program analytics based on historical data, consumer segmentation, propensity models, and spending impact. The graphical representations can include icons, graphs, tables, figures, diagrams, charts, or other visual images. The process also automatically moves the loyalty program icons in a descending list based on determined relative effectiveness. If the UI is a GUI, then the process can automatically move the icons to a position on the GUI in a descending list. The purpose for automatically moving the loyalty program icons in a descending list based on determined relative effectiveness is to improve the human-machine interaction for non-technical users. Thus, the icons and graphical representations provide concise explanations or clear visualizations of data.

At step 422, an operator can configure the ALD framework via a UI. The operator can adjust the weights used in the recurrent comparison step at 414. The operator can also implement guardrails and set limits on a user's access to the ALD framework.

Finally, at step 424, the loyalty data relating to a user's implemented loyalty program is stored in a customer loyalty program database. The loyalty consumer activity data and the loyalty program activity data stored in the customer loyalty program database can be sent to the database of historical transactions used in step 402, thereby further increasing the volume of loyalty data available.

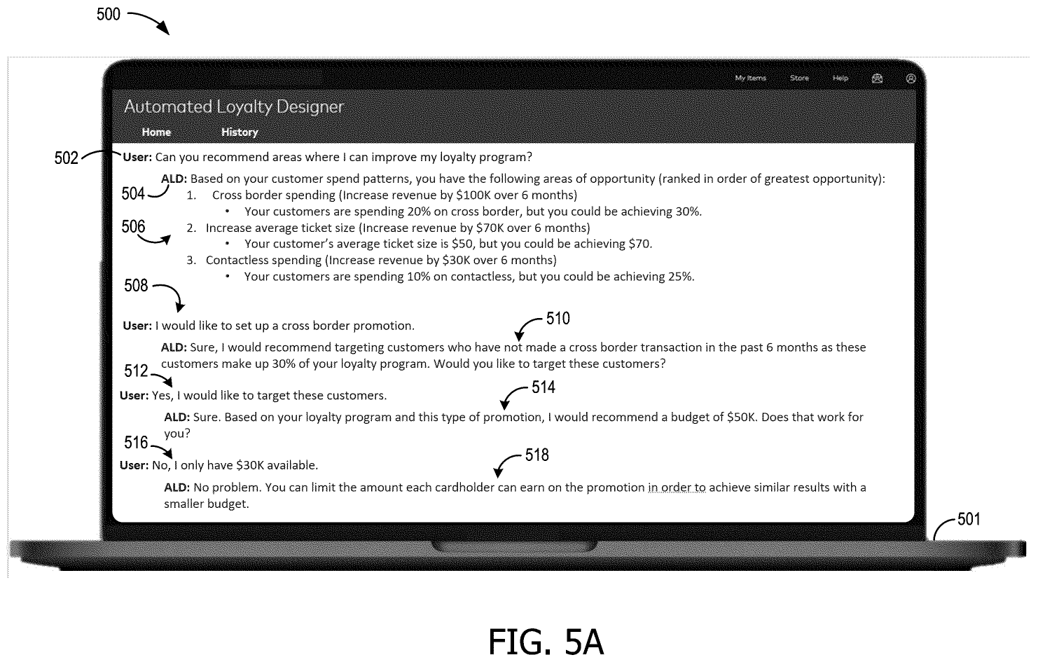

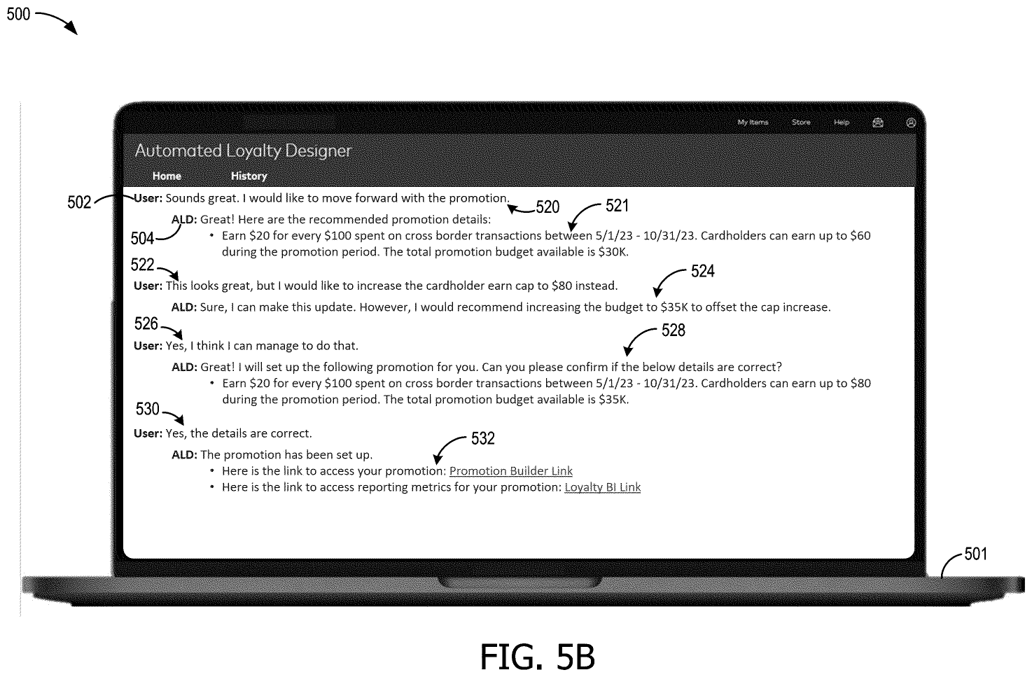

FIG. 5A is an exemplary illustration of a UI 500 operating on a computing device 501 that allows a user 502 to converse with an ALD framework 504 to propose and implement loyalty programs. The user 502 can interact with the UI 500 using natural language, and the UI 500 produces natural language responses using text and images from the ALD framework 504. The ALD framework 504 can be implemented as described above in FIGS. 1-4.

In the example, the user 502 asks the ALD framework 504 if it can recommend ways to improve its loyalty program. In response, the UI 500 presents icons of proposed loyalty programs 506. The icons can be images, text descriptions, some combination of both, or some other visual representations. The UI 500 can automatically move the icons to a position on the GUI in a descending list based on a determined relative effectiveness of the loyalty programs.

The user 502 can then respond with a chosen option 508 or can ask for more options. The ALD framework 504 responds with a more in-depth explanation of the loyalty program 510. The explanation can include a comparison of the user's existing loyalty program consumers and ask for further clarification if a loyalty program is targeting a subset of the user's consumers.

In the example, the user 502 responds that it wants to target consumers who make cross border transactions 512. The ALD 504 framework then proposes a budget to implement the loyalty program 514. The proposed budget can be based on historical data and can be a loyalty program attribute determined in a propensity analysis. In the example, the user 502 responds that it does not have the funds to implement the loyalty program as proposed 516. The ALD 504 framework responds with a modification to the proposed loyalty program to meet the user's reduced budget 518.

In FIG. 5B, the conversation between the user 502 and the ALD framework 504 continues with the user 502 accepting the ALD framework's proposed modification 520. The ALD framework 504 responds with details of the proposed loyalty program 521. The ALD framework 504 can explain the loyalty program's details in natural language, thereby preventing the user from needing any specialized knowledge or expertise to understand the loyalty program.

In the example, the user 502 requests an alteration to the details of the proposed loyalty program 522 that changes the underlying financial mechanism of the loyalty program. The ALD framework 504 responds that it can update the loyalty program, but that it recommends an increase in the budget to offset the modifications 524. The user responds that the new budget is acceptable 526 and that it is feasible to implement.

In response, the ALD framework 504 offers to set up the loyalty program for the user 528. The ALD framework 504 restates the critical loyalty program details and asks for the user to confirm that they are correct. The user 502 responds that the details are correct 530 and the ALD framework 504 provides a link for the user to access the newly created promotion and a link to access the reporting metrics for the promotion 532.

The UI 500 deduces the needs of the user 502 and creates options for the users' loyalty program, promotion, or service without requiring the user to have subject-matter expertise. The ALD framework 504 asks the user 502 questions and guides the user throughout the process of setting up a loyalty program. The ALD framework's 504 explanations are configured to be presented with non-technical language to allow users without technical knowledge to implement loyalty programs.

The implementation of a propensity analysis and RLHF prevents the UI 500 reduces the likelihood of mistakes in the proposed loyalty programs. In particular, the propensity analysis based on historical data will ensure that proposed loyalty programs are presented with a realistic budget to implement the program.

### Exemplary Operating Environment

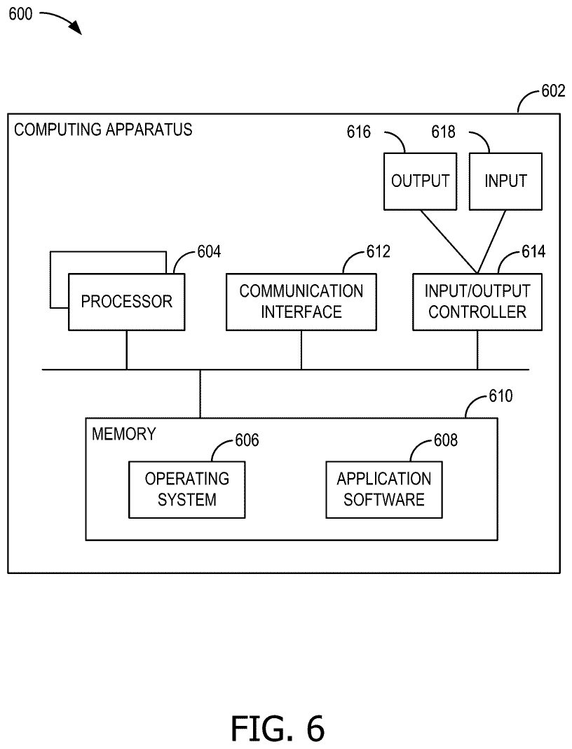

The present disclosure is operable with a computing apparatus according to an embodiment as a functional block diagram of a computing system 600 in FIG. 6. In an embodiment, components of a computing apparatus 602 may be implemented as a part of an electronic device according to one or more embodiments described in this specification. The computing apparatus 602 comprises one or more processors 604 which may be microprocessors, controllers, or any other suitable type of processors for processing computer executable instructions to control the operation of the electronic device. Alternatively, or in addition, the processor 604 is any technology capable of executing logic or instructions, such as a hardcoded machine. Platform software comprising an operating system 606 or any other suitable platform software may be provided on the apparatus 602 to enable application software 608 to be executed on the device.

Computer executable instructions may be provided using any computer-readable media that are accessible by the computing apparatus 602. Computer-readable media may include, for example, computer storage media such as a memory 610 and communications media. Computer storage media, such as the memory 610, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus.

In contrast, communication media may embody computer readable instructions, data structures, program modules, or the like in a modulated data signal, such as a carrier wave, or other transport mechanism. As defined herein, computer storage media do not include communication media. Therefore, a computer storage medium does not include a propagating signal. Propagated signals per se are not examples of computer storage media. Although the computer storage medium (the memory 610) is shown within the computing apparatus 602, it will be appreciated by a person skilled in the art that the storage may be distributed or located remotely and accessed via a network or other communication link (e.g., using a communication interface 612).

The computing apparatus 602 may comprise an input/output controller 614 configured to output information to one or more output devices 616, for example a display or a speaker, which may be separate from or integral to the electronic device. The input/output controller 614 may also be configured to receive and process an input from one or more input devices 618, for example, a keyboard, a microphone, or a touchpad. In one embodiment, the output device 616 may also act as the input device. An example of such a device may be a touch sensitive display. The input/output controller 614 may also output data to devices other than the output device, e.g., a locally connected printing device. In some embodiments, a user may provide input to the input device(s) 618 and/or receive output from the output device(s) 616.

The functionality described herein can be performed, at least in part, by one or more hardware logic components. According to an embodiment, the computing apparatus 602 is configured by the program code when executed by the processor 604 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a computer storage medium storing instructions that are operative upon execution by the processor to: retrieve, from a database of historical transactions, loyalty data comprising loyalty program activity data describing attributes of loyalty programs and loyalty consumer activity data describing consumer transactions associated with a loyalty program; anonymize the loyalty data, wherein any individual identifying information is masked and wherein the loyalty consumer activity data is aggregated; encode the anonymized loyalty data into representations for transformation by a generative pre-trained transformer (GPT); decode the representations from the GPT into a plurality of proposed loyalty programs and a proposed propensity for each proposed loyalty program, wherein the proposed propensity is a likelihood for consumers to make transactions for a given loyalty program; compare the proposed propensity for each proposed loyalty program with a threshold propensity, wherein the threshold propensity is a minimum acceptable propensity for consumers to make transactions in any loyalty program; based on comparing the proposed propensity for each proposed loyalty program with the threshold propensity, determine a relative effectiveness of each proposed loyalty program; present each proposed loyalty program as a natural language icon in a graphical user interface (GUI); and automatically move the natural language icons to a list in the GUI in descending order of relative effectiveness.

An example computerized method comprises retrieving from a database of historical transactions, loyalty data comprising loyalty program activity data describing attributes of loyalty programs and loyalty consumer activity data describing consumer transactions associated with a loyalty program; anonymizing the loyalty data, wherein any individual identifying information is masked and wherein the loyalty consumer activity data is aggregated; encoding the anonymized loyalty data into representations for transformation by a generative pre-trained transformer (GPT); decoding the representations from the GPT into a plurality of proposed loyalty programs and a proposed propensity for each proposed loyalty program, wherein the proposed propensity is a likelihood for consumers to make transactions for a given loyalty program; comparing the proposed propensity for each proposed loyalty program with a threshold propensity, wherein the threshold propensity is a minimum acceptable propensity for consumers to make transactions in any loyalty program; based on comparing the proposed propensity for each proposed loyalty program with the threshold propensity, determining a relative effectiveness of each proposed loyalty program; presenting each proposed loyalty program as a natural language icon in a graphical user interface (GUI); and automatically moving the natural language icons to a list in the GUI in descending order of relative effectiveness.

An example computer storage medium has computer-executable instructions that, upon execution by a processor, cause the processor to at least: retrieving from a database of historical transactions, loyalty data comprising loyalty program activity data describing attributes of loyalty programs and loyalty consumer activity data describing consumer transactions associated with a loyalty program; anonymizing the loyalty data, wherein any individual identifying information is masked and wherein the loyalty consumer activity data is aggregated; encoding the anonymized loyalty data into representations for transformation by a generative pre-trained transformer (GPT); decoding the representations from the GPT into a plurality of proposed loyalty programs and a proposed propensity for each proposed loyalty program, wherein the proposed propensity is a likelihood for consumers to make transactions for a given loyalty program; comparing the proposed propensity for each proposed loyalty program with a threshold propensity, wherein the threshold propensity is a minimum acceptable propensity for consumers to make transactions in any loyalty program; based on comparing the proposed propensity for each proposed loyalty program with the threshold propensity, determining a relative effectiveness of each proposed loyalty program; presenting each proposed loyalty program as a natural language icon in a graphical user interface (GUI); and automatically moving the natural language icons to a list in the GUI in descending order of relative effectiveness.

Alternatively, or in addition to the other examples described herein, examples include any combination of the following:
a configuration manager tool configured to allow an operator to modify a weight of the proposed propensity for each proposed loyalty program;
incorporate the loyalty consumer activity data into decoding the representations from the GPT into the proposed propensity for each proposed loyalty program;
wherein the proposed loyalty programs are compatible with a user's consumer data;
encode the user's consumer data into the GPT, wherein the loyalty programs decoded from the GPT are compatible with the user's consumer data;
a text-based natural-language UI;
a natural language processing module configured to enable a user to interface with the system using text-based queries, wherein the natural language processing module is further configured to modify a proposed loyalty program in response to a user query;
generate graphical representations of analytics of historical data, consumer segmentation, propensity models, or spend impact;
present the graphical representations on the GUI;
wherein the loyalty consumer activity data includes transaction data following a consumer decision to accept or reject previously offered loyalty programs including a result of the decision itself;
analyze a consumer's response to the proposed loyalty programs; and
model consumer responses based on attributes of previously offered loyalty programs.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It is understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for automatically designing loyalty programs, the system comprising:
a processor; and
a computer storage medium storing instructions that are operative upon execution by the processor to:
retrieve, from a database of historical transactions, loyalty data comprising loyalty program activity data describing attributes of loyalty programs and loyalty consumer activity data describing consumer transactions associated with a loyalty program;
anonymize the loyalty data, wherein any individual identifying information is masked and wherein the loyalty consumer activity data is aggregated;
encode the anonymized loyalty data into representations for transformation by a generative pre-trained transformer (GPT);
decode the representations from the GPT into a plurality of proposed loyalty programs and a proposed propensity for each proposed loyalty program, wherein the proposed propensity is a likelihood for consumers to make transactions for a given loyalty program;
compare the proposed propensity for each proposed loyalty program with a threshold propensity, wherein the threshold propensity is a minimum acceptable propensity for consumers to make transactions in any loyalty program;
based on comparing the proposed propensity for each proposed loyalty program with the threshold propensity, determine a relative effectiveness of each proposed loyalty program;
present each proposed loyalty program above the threshold propensity as a natural language icon in a graphical user interface (GUI); and
automatically move the natural language icons to a list in the GUI in descending order of relative effectiveness.

2. The system of claim 1, further comprising a configuration manager tool, wherein the configuration manager tool is configured to allow an operator to modify a weight of the proposed propensity for each proposed loyalty program.

3. The system of claim 1, wherein the instructions are further operative to:
incorporate the loyalty consumer activity data into decoding the representations from the GPT into the proposed propensity for each proposed loyalty program, wherein the proposed loyalty programs are compatible with a user's consumer data; and
encode the user's consumer data into the GPT, wherein the loyalty programs decoded from the GPT are compatible with the user's consumer data.

4. The system of claim 1, further comprising:
a text-based natural-language UI; and
a natural language processing module configured to enable a user to interface with the system using text-based queries, wherein the natural language processing module is further configured to modify a proposed loyalty program in response to a user query.

5. The system of claim 1, wherein the instructions are further operative to:
generate graphical representations of analytics of historical data, consumer segmentation, propensity models, and spend impact; and
present the graphical representations on the GUI.

6. The system of claim 1, wherein the loyalty consumer activity data includes transaction data following a consumer decision to accept or reject previously offered loyalty programs including a result of the consumer decision.

7. The system of claim 1, wherein the instructions are further configured to:
analyze a consumer's response to the proposed loyalty programs; and
model consumer responses based on attributes of previously offered loyalty programs.

8. A method for automatically designing loyalty programs, the method comprising:
encoding anonymized loyalty data into representations for transformation by a generative pre-trained transformer (GPT), the anonymized loyalty data comprising loyalty program activity data describing attributes of loyalty programs and loyalty consumer activity data describing consumer transactions associated with a loyalty program;
decoding the representations from the GPT into a plurality of proposed loyalty programs and a proposed propensity for each proposed loyalty program, wherein the proposed propensity is a likelihood for consumers to make transactions for a given loyalty program;
based on the proposed propensity for each proposed loyalty program, recurrently weighting the GPT using reinforced learning from human feedback (RLHF);
comparing the proposed propensity for each proposed loyalty program with a threshold propensity, wherein the threshold propensity is a minimum acceptable propensity for consumers to make transactions in any loyalty program;
based on comparing the proposed propensity for each proposed loyalty program with the threshold propensity, determining a relative effectiveness of each proposed loyalty program;
presenting each proposed loyalty program above the threshold propensity as a natural language icon in a graphical user interface (GUI); and
automatically moving the natural language icons to a list in the GUI in descending order of relative effectiveness.

9. The method of claim 8, further comprising:
providing a configuration manager tool, wherein the configuration manager tool is configured to allow an operator to modify a weight of the proposed propensity for each proposed loyalty program.

10. The method of claim 8, further comprising:
incorporating the loyalty consumer activity data into decoding the representations from the GPT into the proposed propensity for each proposed loyalty program, wherein the proposed loyalty programs are compatible with a user's consumer data; and
encoding the user's consumer data into the GPT, wherein the loyalty programs decoded from the GPT are compatible with the user's consumer data.

11. The method of claim 8, further comprising:
providing a text-based natural-language UI; and
providing a natural language processing module configured to enable a user to use text-based queries with the text-based natural-language UI; and
modifying, via the natural language processing module, a proposed loyalty program in response to a user query.

12. The method of claim 8, further comprising:
generating graphical representations of analytics of historical data, consumer segmentation, propensity models, and spend impact; and
presenting the graphical representations on the GUI.

13. The method of claim 8, wherein the loyalty consumer activity data includes transaction data following a consumer decision to accept or reject previously offered loyalty programs including a result of the consumer decision.

14. The method of claim 8, further comprising:
analyzing a consumer's response to offered loyalty programs; and
modeling consumer responses based on attributes of previously offered loyalty programs.

15. A computer storage device having computer-executable instructions stored thereon, which, upon execution by a computer, cause the computer to perform operations comprising:
retrieving from a database of historical transactions, loyalty data comprising loyalty program activity data describing attributes of loyalty programs and loyalty consumer activity data describing consumer transactions associated with a loyalty program;
anonymizing the loyalty data, wherein any individual identifying information is masked and wherein the loyalty consumer activity data is aggregated;
encoding the anonymized loyalty data into representations for transformation by a generative pre-trained transformer (GPT);
decoding the representations from the GPT into a plurality of proposed loyalty programs;
determining a proposed propensity for each proposed loyalty program based on a spend impact analysis and consumer response modeling, wherein the proposed propensity is a likelihood for consumers to make transactions for a given loyalty program;
comparing the proposed propensity for each proposed loyalty program with a threshold propensity, wherein the threshold propensity is a minimum acceptable propensity for consumers to make transactions in any loyalty program;
based on comparing the proposed propensity for each proposed loyalty program with the threshold propensity, determining a relative effectiveness of each proposed loyalty program;
presenting each proposed loyalty program above the threshold propensity as a natural language icon in a graphical user interface (GUI); and
automatically moving the natural language icons to a list in the GUI in descending order of relative effectiveness.

16. The computer storage device of claim 15, the instructions further causing the computer to perform operations comprising:
providing a configuration manager tool, wherein the configuration manager tool is configured to allow an operator to modify a weight of the proposed propensity for each proposed loyalty program.

17. The computer storage device of claim 15, the instructions further causing the computer to perform operations comprising:
incorporating the loyalty consumer activity data into decoding the representations from the GPT into the proposed propensity for each proposed loyalty program, wherein the proposed loyalty programs are compatible with a user's consumer data; and
encoding the user's consumer data into the GPT, wherein the loyalty programs decoded from the GPT are compatible with the user's consumer data.

18. The computer storage device of claim 15, the instructions further causing the computer to perform operations comprising:
providing a text-based natural-language UI; and
providing a natural language processing module configured to enable a user to use text-based queries with the text-based natural-language UI; and
modifying, via the natural language processing module, a proposed loyalty program in response to a user query.

19. The computer storage device of claim 15, the instructions further causing the computer to perform operations comprising:
generating graphical representations of analytics of historical data, consumer segmentation, propensity models, and spend impact; and
presenting the graphical representations on the GUI.

20. The computer storage device of claim 15, the instructions further causing the computer to perform operations comprising:
analyzing a consumer's response to previously offered loyalty programs; and
modeling consumer responses based on attributes of previously offered loyalty programs.
